(19) United States
(12) Patent Application Publication
(10) Pub. No.: US 2015/0137685 A1
(43) Pub. Date: May 21, 2015

(54) LAMP FUSE IN PRESS SEAL CAVITY

(71) Applicants: Arturo De Santiago, El Paso, TX (US); Victor Cordero, Juarez (MX)

(72) Inventors: Arturo De Santiago, El Paso, TX (US); Victor Cordero, Juarez (MX)

(73) Assignee: OSRAM SYLVANIA INC., Danvers, MA (US)

(21) Appl. No.: 14/230,974

(22) Filed: Mar. 31, 2014

(51) Int. Cl. H01K 1/66; H01K 1/38

(52) U.S. Cl. CPC H01K 1/66; H01K 1/38
USPC 315/127

(57) ABSTRACT

A lamp (10), such as a rapid thermal processing (“RTP) lamp, is sealed with a press seal (30) that contains a fuse (40). A relatively long press seal region is used that accommodates, in addition to the conventional filament leads to the exterior of the lamp, the fuse as well, the fuse (40) being disposed inside an inert-gas filled void (34) which is formed in the press seal (30), the fuse being thus disposed in an inert environment, such as nitrogen. The void (34) is defined by a bubble (36) formed in the press seal. Alternatively, the void (34) can be defined by an inside region of a glass capillary tube (42) that jackets the fuse and is squeezed into the press seal.

### CROSS REFERENCE TO RELATED APPLICATIONS

N/A

### TECHNICAL FIELD

The present disclosure relates generally to a lamp with a press seal and a fuse, in particular for high current rapid thermal processing (“RTP”) lamps.

### BACKGROUND AND PRIOR ART

The following lamps are known: U.S. Pat. No. 5,345,144 (Mahonski); U.S. Pat. No. 5,205,769 (Mahonski); U.S. Pat. No. 5,264,756 (Westlund, Jr.); U.S. Pat. No. 4,066,926 (Newton); U.S. Pat. No. 3,717,783 (Notelteirs); U.S. Pat. No. 4,570,104 (Janssen); U.S. Pat. No. 6,639,364 (Woods); U.S. Pat. No. 4,922,155 (Morris); U.S. Pat. No. 4,132,922 (Newton); U.S. Pat. No. 3,710,169 9 T'Jampens); U.S. Pat. No. 4,415,836 (De Cuester); U.S. Pat. No. 4,398,124 (Kohl); U.S. Pat. No. 3,796,914 (De Caro); and U.S. published Appin. US 2003/0076026 (Trent).

It is known that a conventional RTP lamp contains a filament inside a capsule with a press seal end, the capsule being held inside a stainless steel sleeve with a fuse external to the press seal region. The fuse and press seal portion of the capsule are encased in a potting compound held within the stainless steel sleeve.

### BRIEF DESCRIPTION OF THE DRAWINGS

Reference should be made to the following detailed description, read in conjunction with the following figures, wherein like numerals represent like parts:

FIG. 1 illustrates a perspective view of a lamp;

FIG. 2 illustrates a lateral side view of the lamp;

FIG. 3 illustrates a front view of the lamp;

FIG. 4 illustrates a transverse cross section along section line A-A in FIG. 3 through press seal bubble 36 in press seal 30;

FIG. 5 illustrates a longitudinal cross section along section line B-B in FIG. 3 through press seal bubble 36 in press seal 30;

FIG. 6 illustrates an alternate construction labeled Section B′-B′ through press seal 30.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient. Also, it should be understood that the phraseology and terminology used herein is for the purpose of description and should not be regarded as limiting.

### DETAILED DESCRIPTION INCLUDING BEST MODE OF A PREFERRED EMBODIMENT

In general, the present disclosure concerns a lamp that is sealed with a press seal and having a fuse. Compact high current rapid thermal processing (“RTP) lamps are desired in the marketplace, and find application for example in semiconductor processing where intense heat is required. A relatively long press seal region is used that accommodates, in addition to the conventional filament leads to the exterior of the lamp, the fuse as well, the fuse being disposed inside an inert-gas filled void which is formed in the press seal, the fuse being thus disposed in an inert environment. The void is defined by a bubble formed in the press seal. Alternatively, the void can be defined by an inside region of a glass capillary tube that jackets the fuse and is squeezed into the press seal. Such a lamp draws high current, at or in excess of 5 amps, and provides satisfactory heat dissipation. The fuse is made of metal with a high melting point, such as molybdenum.

Some advantages of the present embodiment are that the lamp capsule does not need to be enclosed in a stainless steel tube or require potting compound. This embodiment reduces the number of components as well as assembly steps such as locating a metal sleeve, inserting potting compound, fuse insulation, and curing the potting material.

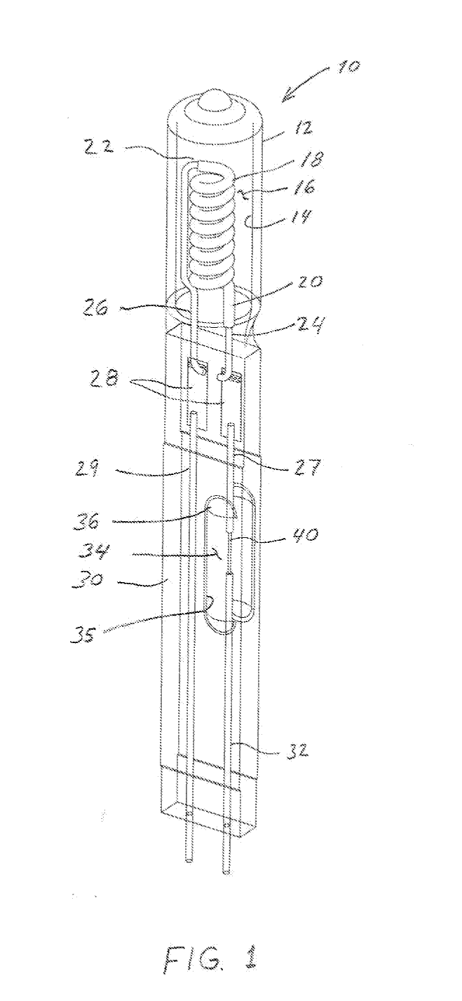

FIGS. 1-3 show a preferred embodiment of a lamp 10 with an internally pressed fuse 40, that is a fuse housed in the press seal 30. Lamp 10 is preferably an RTP lamp. Advantageously, fuse 40 is inside a bubble or cavity 36 in press seal 30. Lamp 10 is assembled from envelope 12, filament 18, inner leads 24, 26 and seal foils 28. Lamp envelope 12 has an internal surface 14 that defines the first enclosed volume 16 in which filament 18 is disposed. Along a first end 20 of filament 18, the inner lead 24 extends into press seal 30 where it is connected to one foil 28, which, internal to press seal 30, is in turn connected to an internal lead segment 27 that is welded to fuse 40, and fuse 40 is in turn connected to a first external lead 32 that extends from press seal 30 to an exterior of lamp 10 for making electrical connection. Along a second end 22 of filament 18, inner lead 26 extends into press seal 30 where it is connected to the other foil 28 which is in turn connected to a second external lead 29 that extends from press seal 30 to an exterior of lamp 10 for making electrical connection. The connections between electrical leads, which are typically made of metal wire, and the foils and with the fuse are typically made by welding. Seal foils 28 are commonly made of molybdenum foil that is welded to the inner leads 24, 26, and welded to the internal lead segment 27 and also welded to the second external lead 29. Construction details of conventional leads and seal foils are described in U.S. Pat. No. 5,264,756 (Westlund) which is hereby incorporated by reference as if fully set forth herein.

Envelope 12 has an inner surface 14 that defines a first enclosed volume 16. A non-oxidizing atmosphere is produced inside enclosed volume 16. In a known manner an inert gas such as nitrogen is introduced into and held in enclosed volume 16. Filament 18 may be a coiled coil tungsten filament as is known in the art. Envelope 12 is made from a quartz tube. In a process known from the conventional art, nitrogen and argon are used to displace the oxygen (and ambient atmosphere) and thus avoid that components of the electrical mount (filament 18, seal foils 28, electrical conductor supports 24, 26, 29, 32, fuse 40) oxidize in the process of the heating. As is known in the art, the inert gas can be introduced into the quartz tube from which envelope 12 is formed through a tabulation or through an open end of the quartz tube, as convenient.

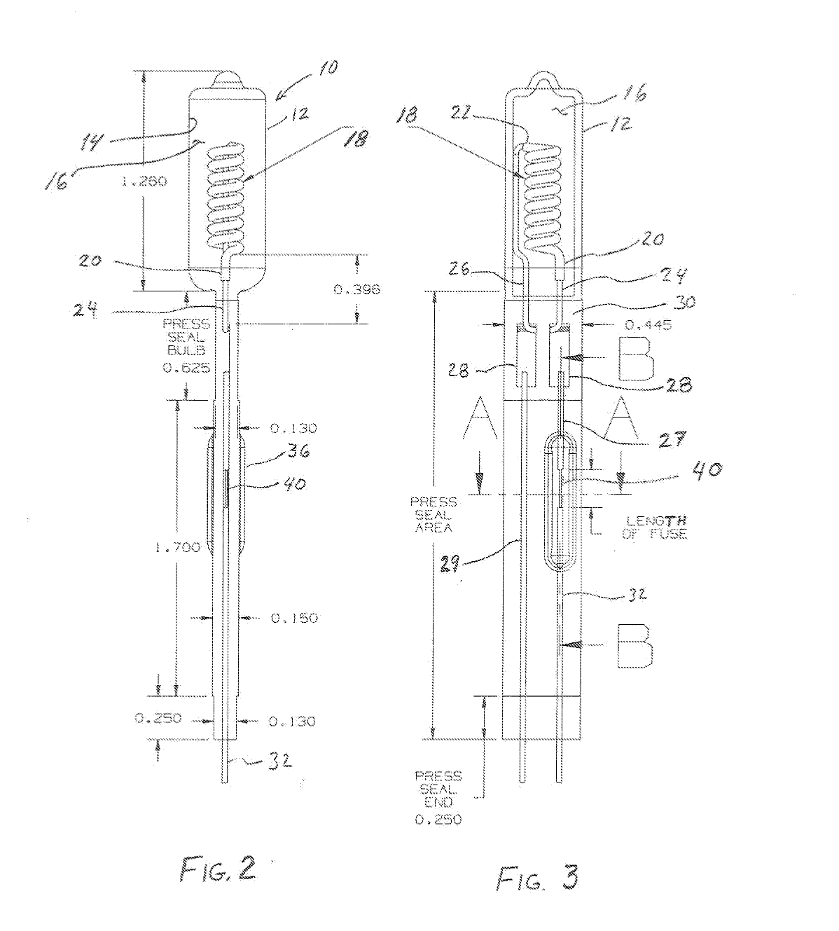

Envelope 12, in press seal region 30 during manufacture, is heated to a plastic state and pressed to enclose and seal with seal foils 28. Over the length of press seal region 30, the thickness of the press seal can be non-uniform. It has been found advantageous that over the region of seal foils 28, the press seal thickness as shown in FIG. 2 is about 0.13 inches (3.3 mm), dimensions on the figures being in inch units. Below the seal foil 28 region, press seal 30 has, in the fuse area, which can have on overall length in the range of about 0.75 inch (19 mm) to about 1.7 inch (43 mm), as a consequence of not being pressed as tightly, a larger thickness of about 0.15 inch (3.8 mm). At the distal end of press seal 30 more remote from envelope 12 and seal foils 28, press seal 30 is pressed to preferably the same thickness about 0.13 inch (3.3 mm) adjacent where first and second external leads 32, 29 emerge from press seal 30 to an exterior of lamp 10. Advantageously, the resultant overall press seal 30 has length that exceeds 1.3 inch (33 mm) and can exceed 2 inches (50 mm) and accomplishes simple insertion into a corresponding socket. An advantage of the use of such a relatively long and slender lamp 10, devoid of having a typical stainless steel sleeve in which a conventional externally fused capsule has heretofore been potted, is that lamp 10 is more compact such that more RTP lamps can be accommodated in the same area of a heating chamber and/or provide more space to cool the system.

In a working example, fuse 40 is made of molybdenum wire having 0.012″ (inch) diameter, this is a size believed suitable for a 620 Watt/92 Volt capsule. One of ordinary skill in the art appreciates to choose an appropriate wire diameter, considering the transversal area of the fuse, depending on the particular choice of wattage and voltage (or current) of the lamp for its particular application.

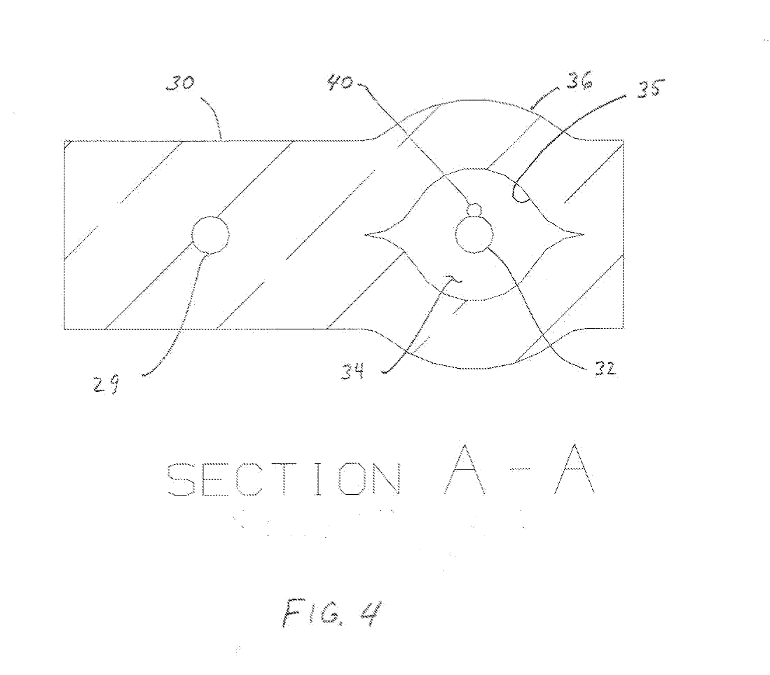

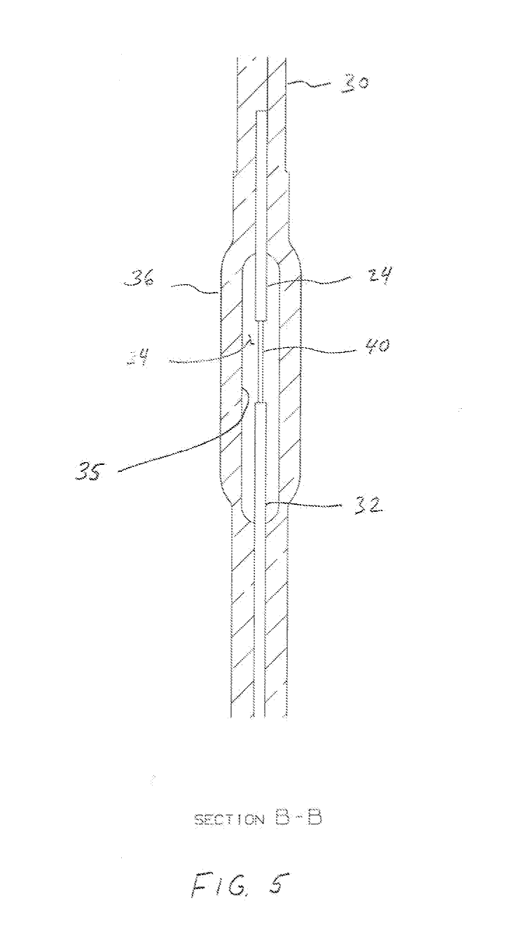

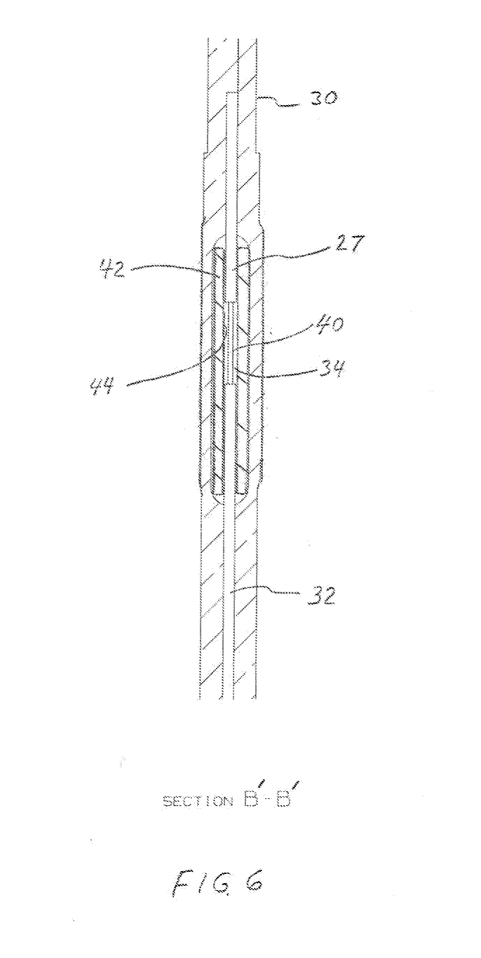

As shown in for example FIGS. 2-3, and in detail in cross-sectional views of FIGS. 4 and 5, press seal 30 has a cavity or bubble 36. Bubble 36 is formed in the glass wall of press seal 30 as being outwardly convex on both front and rear faces (which are otherwise generally flat) of press seal 30. Bubble 36 has internal surface 35 which defines a void referred to as press seal internal volume 34. Press seal internal volume 34 is separate from, and not in fluidic communication with, filament envelope volume 16 in which filament 18 is located. Fuse 40 is not pinched or restrained by internal surface 35 of bubble 36. Fuse 40 is preferably spaced from internal surface 35 of bubble 36, and most preferably spaced in all lateral directions from internal surface 35. An RTP lamp typically draws high current. When fuse 40 goes off, e.g. melts, bubble 36 filled with inert gas, e.g. nitrogen, acts as an arc extinguisher. This arrangement of fuse 40 allows some room for the arc to extinguish before the energy trapped can rupture press seal 30. As suggested in FIG. 4, as seen in lateral cross section, adequate room is provided where internal diameter of bubble 36 is about 8× or 10× wire size of fuse 40. Preferably and advantageously, fuse 40 is laterally surrounded by the inert atmosphere, and does not contact internal surface 35. Preferably fuse 40 is not in contacting relationship to internal surface 35 or to bubble 36. Fuse 40 is sufficiently supported by just the electrical leads internal lead segment 27 and first external lead 32 to maintain its position. That is, fuse 40 is preferably exclusively supported by those electrical leads and does not need to be supported by internal surface 35.

An assembly step for forming bubble 36 will be described. In known press sealing processes, heated glass of the quartz tube is formed by a press tool that has two mating faces referred to as press feet. The typical press feet zone is flat, resulting in a conventional flat or generally planar press seal, as is typical in the press seal for the bulb in the region adjacent seal foils 28 or in the most distal region of press seal 30 adjacent the press seal end where external conductors 29, 32 protrude to the exterior. As one of skill in the art will readily appreciate, a portion of the usually flat region of the press foot is provided with a cavity or indent therein, one cavity or indent on each tool face is preferred, and this reliably forms bubble 36 assisted by the flow of inert gas, such as nitrogen. Inert gas from the oxygen flush of filament 18 enclosed in first volume 16 is then also trapped inside bubble 36 and sealed by the press feet tool forming press seal 30.

FIG. 6 illustrates an alternate construction, indicated as Section B′-B′. Instead of forming a bubble 36 as described hereinabove with the embodiment of FIG. 1-FIG. 5, a capillary tube 42 of quartz glass is placed around fuse 40 prior to the assembly step of forming press seal 30. In a similar manner as described above, a generally conventional press foot tool, without a cavity to form a bubble 36, is used in conjunction with the flow of flushing inert gas and fuse 40 surrounded by capillary tube 42 is embedded in press seal 30. An inside region of capillary tube 42 defines a void or press seal internal volume 34. Fuse 40 is not restrained by the inner diameter surface 44 of capillary tube 42. Fuse 40 is spaced from inner diameter surface 44, and the region within capillary tube 42 defines the void or press seal internal volume 34, which contains a non-oxidizing atmosphere, preferably being filled with inert gas. It was observed that fuse 40 in such a construction tends to be more cooling, believed due to the proximity of fuse 40 to glass of the press seal 30, and so fuse 40 was more difficult to melt. The construction of e.g. FIG. 5 having a greater spacing of fuse 40 due to the presence of bubble 36 is preferred.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, are understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

An abstract is submitted herewith. It is pointed out that this abstract is being provided to comply with the rule requiring an abstract that will allow examiners and other searchers to quickly ascertain the general subject matter of the technical disclosure. It is submitted with the understanding that it will not be used to interpret or limit the scope or meaning of the claims, as set forth in the rules of the U.S. Patent and Trademark Office.

The following is a non-limiting list of reference numerals used in the specification:
10 lamp
12 envelope
14 envelope inner surface
16 first enclosed volume
18 filament
20 first end of filament
22 second end of filament
24 inner lead
26 inner lead
28 seal foil
29 second external lead
30 press seal
32 first external lead
34 void or press seal internal volume
35 bubble internal surface
36 bubble or cavity
40 fuse
42 capillary tube
44 inner diameter surface of capillary tube

What is claimed is:

1. A lamp with an internally pressed fuse comprising:
an envelope (12) having an internal surface (14) defining a first enclosed volume (16), and having a press seal (30); and
a filament (18) disposed in said first enclosed volume, an inner lead (24) extending from a first end (20) of the filament (18) into the press seal (30) electrically coupled in series to a fuse (40) pressed in the press seal (30), the fuse (40) being electrically coupled in series to a first external lead (32) extending from the press seal (30) to an exterior of the lamp, the filament (18) being further connected through a second filament end (22) to the exterior of the lamp for electrical connection,
wherein said press seal (30) further has an inner press seal surface (35; 44) defining a press seal internal volume (34) containing a non-oxidizing atmosphere, said fuse (40) being disposed in said press seal internal volume (34).

2. The lamp of claim 1, wherein said non-oxidizing atmosphere comprises an inert gas.

3. The lamp of claim 2, wherein said inert gas comprises nitrogen.

3. The lamp of claim 1, wherein said fuse (40) is disposed in said press seal internal volume (34) in spaced relation to said inner press seal surface (35; 44).

4. The lamp of claim 1, wherein said press seal internal volume (34) is not in communication with said first enclosed volume (16).

5. The lamp of claim 1, wherein said press seal internal volume (34) is defined by a bubble (36) formed in said press seal (30).

6. The lamp of claim 1, wherein said press seal internal volume (34) is defined by a region inside a capillary tube (42) surrounding said fuse (40) and contained within said press seal (30).
